(19) United States
(12) Patent Application Publication
(10) Pub. No.: US 2006/0231243 A1
(43) Pub. Date: Oct. 19, 2006

(54) Egr cooler

(75) Inventors: Hiroyuki Sugihara, Tokyo (JP); Makoto Tsujita, Tokyo (JP); Yoji Yamashita, Saitamaa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignees: HINO MOTORS, LTD., Tokyo (JP); SANKYO RADIATOR CO., LTD., Tokyo (JP)

(21) Appl. No.: 10/564,779

(22) PCT Filed: Jul. 12, 2004
(86) PCT No.: PCT/JP04/09939

§ 371 Date: Jan. 17, 2006

(30) Foreign Application Priority Data
Jul. 16, 2003 (JP) 2003-275189

(51) Int. Cl. F28F 9/02; F28F 1/10; F02M 25/07

(52) U.S. Cl. 165/158; 123/568.12; 165/172

(57) ABSTRACT

Provided is an EGR cooler which can solve the problem of the vibrated tubes without causing thermal deformation due to stagnation of the coolant water, without complexity of piping in the coolant water system and without increase in pressure loss.

The EGR cooler comprises tubes 3 and a shell surrounding the tubes 3, the coolant water being supplied and discharged to and from the shell 1 and being passed through the respective tubes 3 so as to make heat exchange of the exhaust gas with the coolant water. In the shell 1, an intermediate support plate 13 with a plurality of through-holes 14 is arranged and mutually adjacent ones of the tubes 3 are grouped for penetratingly fixture to the through-hole 14. A coolant water passage 15 is ensured between the tubes 3 grouped and penetratingly fixed to the same through-hole 14 of the intermediate support plate 13 for free communication between the tubes 3.

### TECHNICAL FIELD

The present invention relates to an EGR cooler attached to an EGR apparatus, which recirculates exhaust gas from an engine to suppress generation of nitrogen oxides, so as to cool the exhaust gas to be recirculated.

### BACKGROUND ART

Known is an EGR apparatus which recirculates part of exhaust gas from an engine in a vehicle or the like to the engine to suppress generation of nitrogen oxides. Some of such EGR apparatuses are equipped with, midway of an exhaust gas recirculation line to the engine, an EGR cooler for cooling the exhaust gas since cooling of the exhaust gas to be recirculated to the engine will drop the temperature of and reduce the volume of the exhaust gas to lower the combustion temperature in the engine without substantial decrease in output of the engine, thereby effectively suppressing generation of nitrogen oxides.

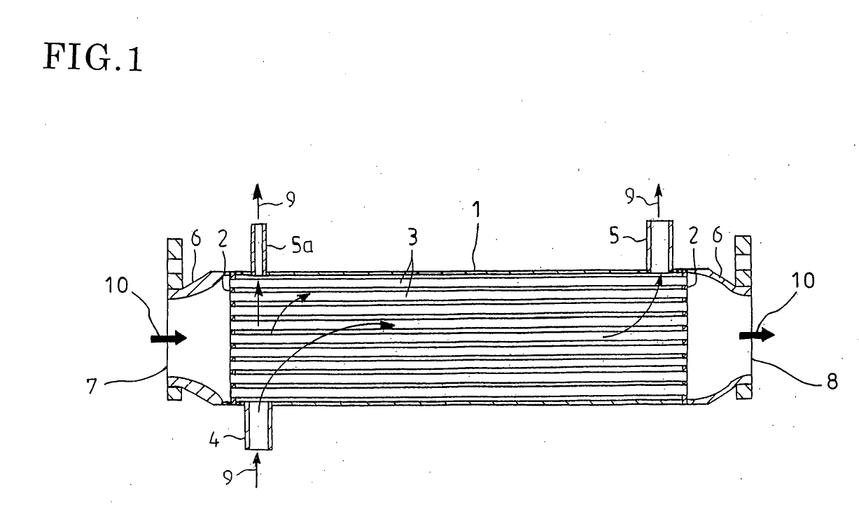

FIG. 1 is a sectional view showing an example of the EGR coolers in which reference numeral 1 denotes a cylindrical shell with axially opposite ends to which plates 2 are respectively fixed so as to close the ends of the shell 1. Penetratingly fixed to the respective plates 2 are opposite ends of a number of tubes 3 which extend axially within the shell 1.

The shell 1 is provided with a coolant-water inlet pipe 4 near one end of the shell 1 and with a coolant-water outlet pipe 5 near the other end of the shell 1 so that coolant water 9 is supplied via the inlet pipe 4 into the shell 1, flows outside of the tubes 3 and is discharged via the outlet pipe 5 from the shell 1.

The respective plates 2 have, on their sides away from the shell 1, bowl-shaped hoods 6 fixed to the respective plates 2 so as to enclose end faces of the plates. The one and the other hoods 6 provide central exhaust gas inlet and outlet 7 and 8, respectively, so that exhaust gas 10 from the engine enters via the inlet 7 into the one hood 6, is cooled during passage through the number of tubes 3 by means of heat exchange with coolant water 9 flowing outside of the tubes 3 and is discharged to the other hood 6 to be recirculated via the outlet 8 to the engine.

In the figure, reference numeral 5a denotes a bypass outlet pipe arranged at a position diametrically opposed to the inlet pipe 4, part of the coolant water 9 being withdrawn through the bypass outlet pipe 5a so as to prevent the coolant water 9 from stagnating at the position opposed to the inlet pipe 4.

However, the tubes 3 are supported only by the plates 2 at their opposite ends in such conventional EGR cooler so that, when the tubes 3 are extended so as to improve cooling effect through the exhaust gas 10, characteristic frequency of the tubes 3 tends to be lowered into conformity with the vibrating frequency of the engine with a disadvantageous result that the tubes 3 may be greatly vibrated due to resonance with the vibration of the engine.

When the tubes 3 are greatly vibrated due to such resonance, the respective tubes 3 tend to have fatigue breakdown for example at their opposite fixed ends, resulting in significant loss in durability.

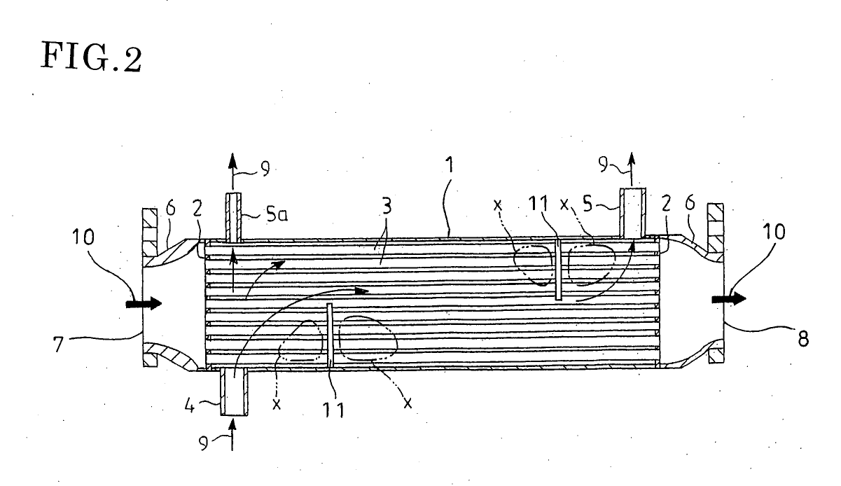

In order to overcome the problem of such vibrated tubes 3, it may be envisaged to employ a structure for example as shown in FIG. 2 which intermediately supports upper and lower halves of the grouped tubes 3 by two semicircular discs 11; portions of the tubes 3 supported by the discs 11 serve as vibration supports so that the free vibrating zone for the tubes 3 is longitudinally divided to enhance characteristic frequencies of the tubes, thereby making it difficult to cause resonance due to vibration of the engine.

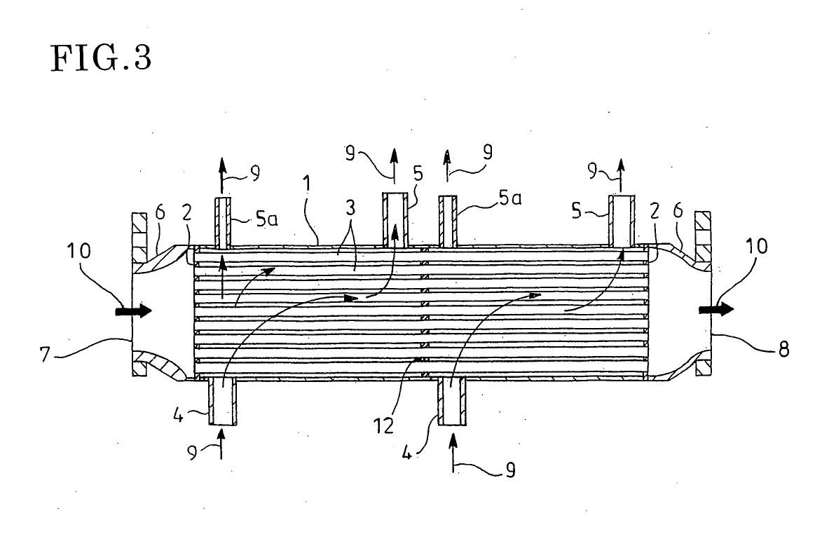

Alternatively, it may be also envisaged that, as shown in FIG. 3, longitudinally intermediately fixed to the interior of the shell 1 is a round partition 12 through which all of the tubes 3 are penetratingly fixed, so that the free vibrating zone of the tubes 3 is longitudinally divided to enhance characteristic vibration of the respective tubes 3. In this case, because of the space in the shell 1 being partitioned by the partition 12, the coolant-water inlet and outlet pipes 4 and 5 are needed for each of the partitioned spaces.

The following Reference 1 is a prior application filed by the applicants of the invention in order to overcome a similar problem of the vibrated tubes 3.

[Reference 1] JP 2002-327654A

### SUMMARY OF THE INVENTION

### PROBLEMS TO BE SOLVED BY THE INVENTION

However, when the EGR cooler shown in FIG. 2 is employed, the provision of the semicircular discs 11 deteriorates the flow of the coolant water 9 so that the coolant water 9 tends to stagnate at positions shown by x in FIG. 2, which may lower the heat exchange efficiency at such stagnating positions to cause local increase in temperature of the tubes 3, resulting in thermal deformation at such portions. On the other hand, when the EGR cooler shown in FIG. 3 is employed, piping of a coolant water system may become complex and pressure loss may be increased to cause difficulty in flow of the coolant water 9.

The invention was made in view of the above and has its object to provide an EGR cooler which can solve the problem of vibrated tubes without causing thermal deformation of tubes due to stagnation of coolant water, without causing complexity of piping in the coolant water system and without increase in pressure loss.

### MEANS OR MEASURES FOR SOLVING THE PROBLEMS

The invention is directed to an EGR cooler comprising tubes and a shell surrounding said tubes, coolant water being fed into and discharged from said shell, exhaust gas being passed through said tubes for heat exchange of said exhaust gas with said coolant water, characterized in that an intermediate support plate with a plurality of through-holes is arranged in the shell, mutually adjacent ones of the tubes being grouped to be penetratingly fixed to each of the through-holes, a coolant water passage being ensured between the adjacent tubes grouped and penetratingly fixed to each of the through-holes in the support plate for free communication of the coolant water between the grouped tubes.

Thus, intermediate portions of the respective tubes are supported by the intermediate support plate so that such supported portions serve as vibration supports to enhance characteristic frequency of the tubes, whereby the tubes are prevented from being greatly vibrated due to resonance with the vibration of the engine to remarkably suppress fatigue breakdown of the respective tubes for example at their fixed opposite ends.

Allowed is free communication of the coolant water via the coolant water passage between the tubes grouped and fixed to each of the through-holes in the intermediate support plate, so that deterioration of the coolant water flow is prevented unlike the prior art with the semicircular discs, whereby the coolant water tends to hardly stagnate so that lowering of the heat exchange efficiency and thermal deformation of the tubes are prevented from occurring.

Further, complexity of the coolant water system is prevented unlike the prior art with the shell partitioned by a partition, whereby averted is increase in pressure loss so that deterioration of the coolant water flow is prevented from occurring.

### EFFECTS OF THE INVENTION

The following excellent effects will be obtained according to an EGR cooler of the invention. The problem of the vibrated tubes can be overcome without causing thermal deformation of the tubes due to stagnation of the coolant water, without causing complexity in piping of the coolant water system and without increasing in pressure loss. As a result, obtainable are excellent effects such that extension of the tubes may be effected with no hindrance to enhance the cooling effect of the exhaust gas and that fatigue breakdown of the tubes for example at their opposite fixed ends may be suppressed to substantially enhance durability.

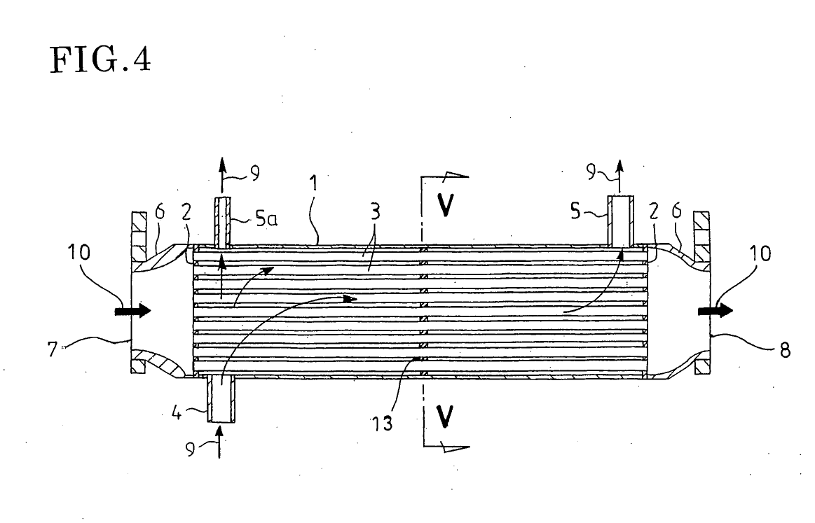

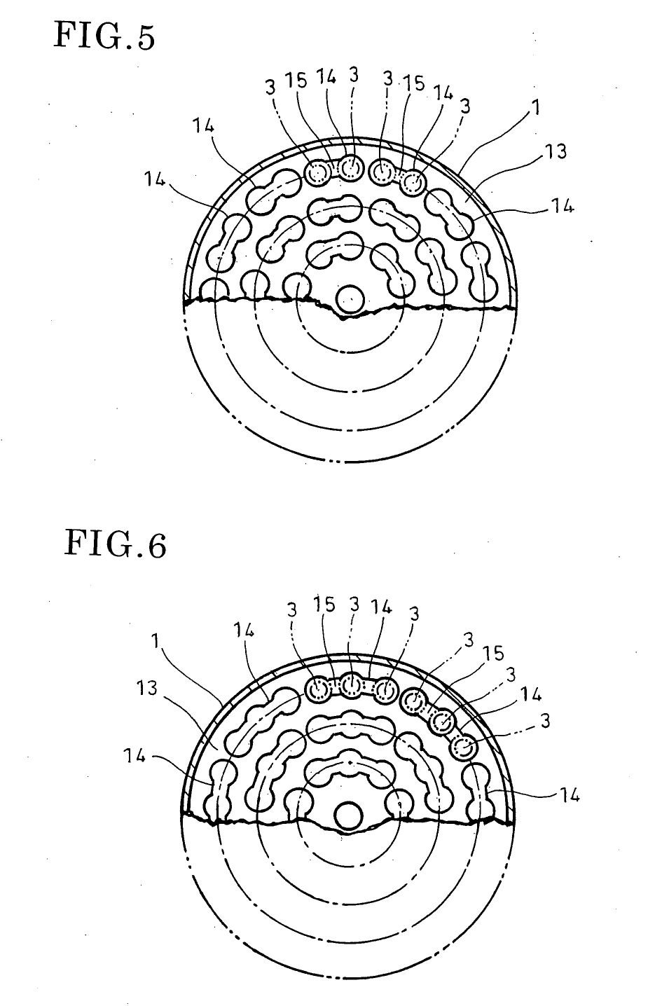

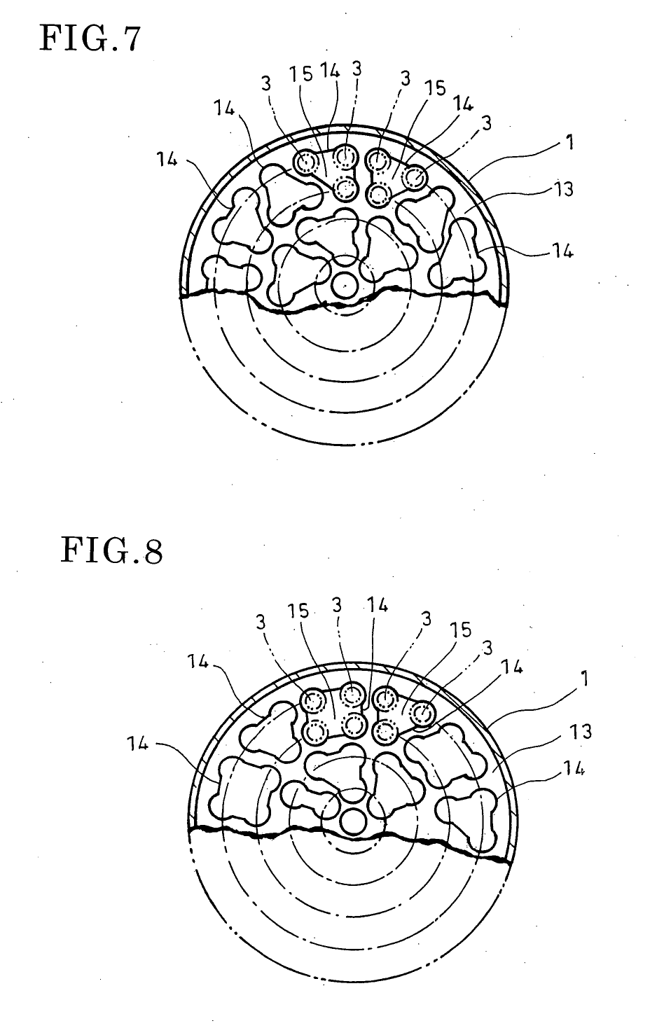

### BRIEF DESCRIPTION OF THE DRAWINGS

[FIG. 1] A sectional view showing an example of a conventional EGR cooler.

[FIG. 2] A sectional view showing a further example of a conventional EGR cooler.

[FIG. 3] A sectional view showing a still further example of a conventional EGR cooler.

[FIG. 4] A sectional view showing an embodiment of the invention.

[FIG. 5] A view looking in the direction of arrows V in FIG. 4.

[FIG. 6] A sectional view showing a further embodiment of the invention.

[FIG. 7] A sectional view showing a still further embodiment of the invention.

[FIG. 8] A sectional view showing a still further embodiment of the invention.

### EXPLANATION OF THE REFERENCE NUMERALS

1 shell

2 plate

3 tube

9 coolant water

10 exhaust gas

13 intermediate support plate

14 through-hole

15 coolant water passage

### MODE FOR CARRYING OUT THE INVENTION

Embodiments of the invention will be described with reference to the drawings.

FIGS. 4 and 5 show an embodiment of the invention in which parts similar to those shown in FIGS. 1-3 are designated by the same reference numerals.

In the EGR cooler according to the embodiment, a round intermediate support plate 13 is arranged at a longitudinally intermediate position within a shell 1. Respective tubes 3 arranged multi-cylidrically about an axis of the shell 1 are penetratingly fixed by the intermediate support plate 13.

The intermediate support plate 13 is formed with a plurality of through-holes 14 for penetrating fixture of the respective tubes 3; each of the through-holes 14 are in the form of cocoon-shaped slits for penetrating fixture of the circumferentially adjacent two tubes 3 in group, the respective tubes 3 fixed to the same through-hole 14 being mutually connected by a coolant-water passage 15 for free communication of the coolant water 9.

It is preferable that each of the passages 15 has a total flow passage area about 2-5 times as large as that of the coolant water inlet or outlet pipe 4 or 5; then, pressure loss of the coolant water 9 may be substantially unchanged or suppressed to rise by several %.

In the embodiment shown, the single intermediate support plate 13 is arranged longitudinally intermediately in the shell 1; alternatively, it is of course possible to arrange a plurality of intermediate support plates 13 in a spaced-apart relationship in accordance with the length of the shell 1.

With the thus constructed EGR cooler, the longitudinally intermediate portions of the respective tubes 3 are supported by the intermediate support plate 13 so that such supported portions serve as vibration supports to enhance characteristic frequency of the tubes 3, whereby the tubes 3 are prevented from being greatly vibrated due to resonance with the vibration of the engine to remarkably suppress fatigue breakdown of the respective tubes 3 for example at their fixed ends.

Allowed is free communication of the coolant water 9 via the coolant water passage 15 between the tubes 3 grouped and fixed to the each of the through-holes 14 in the intermediate support plate 13, so that deterioration in flow of the coolant water 9 is prevented unlike the prior art with the semicircular discs, whereby the coolant water 9 tends to hardly stagnate so that lowering of the heat exchange efficiency and thermal deformation of the tubes 3 are prevented from occurring.

Further, complexity of the coolant water system is prevented unlike the prior art with the shell 1 partitioned by a partition, whereby averted is increase in pressure loss so that deterioration of the coolant water 9 flow is prevented from occurring.

Thus, according to the above embodiment, the problem of the vibrated tubes 3 can be overcome without causing thermal deformation of the tubes 3 due to stagnation of the coolant water 9, without causing complexity in piping of the coolant water system and without increasing in pressure loss. As a result, obtainable are excellent effects such that extension of the tubes 3 may be effected with no hindrance to enhance the cooling effect of the exhaust gas 10 and with no fatigue breakdown of the tubes 3.

FIGS. 6-8 show further embodiments of the invention. In the embodiment shown in FIG. 6, the through-hole 14 in FIG. 5 in the form of cocoon-shaped slit to which the grouped circumferentially adjacent two tubes 3 are penetratingly fixed is further extended circumferentially so that circumferentially adjacent three tubes 3 may be grouped for penetrating fixture.

Further, used in the embodiment shown in FIG. 7 are triangular through-holes 14 through each of which not only circumferentially adjacent two of the tubes 3 but also a radially adjacent single tube 3, i.e. grouped three of the tubes 3 may be penetratingly fixed.

Still further, in the embodiment shown in FIG. 8, rectangular through-holes 14 through each of which circumferentially adjacent two of the tubes 3 and radially adjacent two of the tubes 3, i.e., totally grouped four of the tubes 3 may be penetratingly fixed are mixed with the triangular through-holes 14 in FIG. 7 and/or the cocoon-shaped through-holes 14 in FIG. 5.

In use of any of these embodiments shown in FIGS. 6-8, just like the embodiment shown in FIGS. 4 and 5, the problem of the vibrated tubes 3 can be overcome without causing thermal deformation of the tubes 3 due to stagnation of the coolant water 9, without causing complexity of the piping of the coolant water and without increase in pressure loss.

### INDUSTRIAL APPLICABILITY

It is to be understood that an EGR cooler according to the invention is not limited to the above-mentioned embodiments and that various changes and modifications may be made without leaving the gist of the invention. For example, a plurality of axial portions of the respective tubes may be supported by elastic bodies.

1. An EGR cooler with tubes and a shell surrounding said tubes, coolant water being fed into and discharged from an interior of the shell, exhaust gas being passed through said tubes for heat exchange of said exhaust gas with said coolant water, said EGR cooler comprising an intermediate support plate arranged in said shell and with a plurality of through-holes, mutually adjacent ones of the tubes being grouped to be penetratingly fixed to each of the through-holes, a coolant water passage being ensured between the adjacent tubes grouped and penetratingly fixed to each of the through-holes in the support plate for free communication of the coolant water between the grouped tubes.
